(19) United States
(12) Patent Application Publication
(10) Pub. No.: US 2003/0208616 A1
(43) Pub. Date: Nov. 6, 2003

(54) System and method for testing computer network access and traffic control systems

(75) Inventors: Brian Laing, Redwood City, CA (US); Anthony Haywood, Stevenage (GB)

Correspondence Address: CAPSTONE LAW GROUP LLP, 1810 GATEWAY DRIVE, SUITE 260, SAN MATEO, CA, 94404, US

(73) Assignee: Blade Software, Inc., Redwood City, CA

(21) Appl. No.: 10/271,125

(22) Filed: Oct. 15, 2002

Related U.S. Application Data
(60) Provisional application No. 60/376,957, filed on May 1, 2002.

(51) Int. Cl. G06F 15/16

(52) U.S. Cl. 709/236

(57) ABSTRACT

A system and method of testing a computer network recording header information of data packets in a live traffic pattern on the computer network which identifies source and destination addresses for testing of the computer network; modifies the recorded header information by replacing the source and destination addresses of the recorded header information with the source and destination addresses for testing, and re-calculates the checksum for each data packet based upon the source and destination addresses for testing; and transmits a test traffic pattern with the modified header information on the computer network without establishing a live connection with the destination address.

### STATEMENT OF RELATED CASES

This application claims priority to co-pending provisional application No. 60/376,957.

### TECHNICAL FIELD OF INVENTION

This invention relates generally to the testing of access and traffic control systems, and in particular testing the effectiveness of these systems by launching test attacks or application/network protocols.

### BACKGROUND OF THE INVENTION

Today's networks are under constant attack from threats ranging from the basic computer user experimenting with hacks easily available from the Internet to the technically elite hacker trying to exploit security holes for their own benefit. Protecting against these threats involves using various and complex technologies to detect attacks and protect the network and its assets from these attacks.

Many of the computers connected to today's networks are running various services that can be attacked while the computer is connected to the network. Some machines are running Internet services such as HTTP, FTP, Email, etc., and must be exposed to the network for people to actually use these services. Other services inherent in the operating system itself such as Windows Netbios, UNIX telnet, and others are also vulnerable. Malicious individuals commonly use these and many other services as routes to attack systems to gain unauthorized access and control.

Intrusion Detection Systems (IDS) are dedicated components of the host and network that constantly monitor for attack. When an attack is detected the IDS can initiate various responses based on where the IDS is located. A network IDS can typically reset a network connection or reconfigure a firewall thus preventing continued attack. A host based IDS can take a more active role by preventing the attack from ever reaching the component it was aimed at.

Firewalls and other packet filters sit between potential attackers and their targets to control access. Once the firewall is in place, it either allows or denies network traffic based on pre-configured rules. However, a firewall does not protect services that are allowed through the firewall.

Antivirus software runs on either a network server or individual workstations and monitors constantly for viruses of varied types. Once a virus is detected the anti-virus software can be configured to take various actions such as delete the file, quarantine the file, or if it has the proper information, clean the file to remove the virus.

These various access and traffic control components aim to detect and prevent attacks against computer networks. However, these components can be quite complex to setup, and often it is uncertain whether they are configured properly or indeed even working. Without effective testing, there is no easy way to prove that the access and traffic control components operate in the expected way when under attack or correctly monitor the computer network. There is also no independent assurance that the deployed components defend against the latest attacks.

There are a number of known methods for testing the architecture of computer networks. One such system is offered by Mercury Interactive Corporation of Sunnyvale, Calif. as described in U.S. Pat. No. 6,360,332 by Weinberg et al entitled “Software System And Methods For Testing The Functionality Of A Transactional Server” and in an undated white paper entitled “Load Testing To Predict Web Performance.” This system works with two end points in a network by simulating clients in a client-server environment. Recorded user steps are sent between the simulated clients and a transactional server to load test the network router, firewall, and transactional server. The simulation occurs at the application layer of the OSI model. The responses of the transactional server are monitored and recorded during the iterative play back process. This system provides load testing with connection based user steps rather than attack testing with connectionless data packets. Moreover, the destination and source IP addresses cannot be changed to comprehensively test the network.

NetIQ Corporation of Santa Clara, Calif. also provides a load testing system as described in U.S. Pat. No. 6,397,359 by Chandra et al entitled “Methods, Systems And Computer Program Products For Scheduled Network Performance Testing.” This approach simulates a connection between two endpoints on a network and schedules the execution of test protocols to test the performance of the network, much like the Mercury Interactive system described above. Although this approach tests the network, it does not allow for non-malicious testing of the network with real attacks.

In order to test the security of the network, NetIQ also provides a security analysis tool as described in an online brochure entitled “NetIQ's Security Management and Administration Solution”, an online brochure entitled “Security Analyzer”, and a white paper entitled “Integrating Security Analyzer with Security Manager” dated Aug. 10, 2001. While the NetIQ security analyzer approach provides for testing of a live network, it does so using scripts that look for vulnerabilities in the network rather than launching real attacks. This approach does nothing to determine how the network will react when under a live attack.

U.S. Pat. No. 6,324,656 by Gleichauf et al. discloses a vulnerability testing approach like that provided by NetIQ's security analyzer. Gleichauf teaches the gathering of information by pinging devices on the network to be tested and then performing port scans of those devices. The collected information is then analyzed to determine by comparison to a rule set to determine potential vulnerabilities. This again is an example of a test approach that can test an individual host but does not utilize actual attacks.

Another network testing system that tests network security is provided by Cenzic, Inc. of Cambell, Calif., as described in an undated white paper entitled “Hailstorm Architecture” and a June 2002 white paper entitled “Enabling Security in Software Development.” In the Cenzic approach, the test system acts as a client on the network. Scripts are run with junk data in the packet data fields. The Cenzic system is used to address security vulnerabilities in the software development process. The Cenzic approach suffers from the same limitations as the vulnerability testing approaches discussed above.

Additionally, these vulnerability assessment approaches test the network at the Application layer of the network OSI. This requires the testing to pass though all of the OSI layers to reach the hardware layer, which is the lowest OSI layer. By not connecting directly to the hardware layer, these approaches are limited in the flexibility of the test simulation.

All of these approaches are limited in their ability to test a network's vulnerability to real attacks in a live network setting. In order to fully test a network against live attacks or other network traffic, the actual live attacks or fully modified traffic are launched against the network to determine how the network will react. Modified traffic is a fully protocol stream (http, telnet, ftp, etc.) replayed back with full header manipulation around source or destination IP addresses. However, the testing must take place in a lab environment to avoid putting the live network at risk to the attacks. Those approaches that allow for testing of a live network (e.g. vulnerability assessment, load testing, and virus testing), are incapable of testing how the network will react to the introduction of a real attack.

The present invention provides for testing the effectiveness of these components against live attacks without suffering from the deficiencies found in current systems.

### SUMMARY OF THE INVENTION

The present invention launches copies of real attack or protocol traffic across a computer network to be picked up by the IDS system and other access/traffic control components. The test attacks are built based upon real network traffic, which is recorded and manipulated. The test attacks or protocol traffic are then launched and evaluated to determine how the access/traffic control components coped and responded. The test attacks or protocols that are launched are real attacks or protocols that have been rendered harmless and therefore can cause no damage. However, the access/traffic control components will see the attack or protocol as real traffic and will alert or respond accordingly.

The present invention has other objects and advantages which are set forth in the description of the Best Mode of Carrying Out the Invention. The features and advantages described in the specification, however, are not all inclusive, and particularly, many additional features and advantages will be apparent to one of ordinary skill in the art in view of the drawings and specification herein.

### BRIEF DESCRIPTION OF THE DRAWINGS

FIG. 1 is a block diagram of the logical and physical components of the testing system of the present invention configured for unidirectional testing of a computer network.

FIG. 2 is a block diagram of the logical and physical components of the testing system of the present invention configured for bi-directional testing of a computer network.

FIG. 3 is a block diagram of the logical and physical components of an alternate testing system of the present invention configured for bi-directional testing of a computer network.

FIG. 4 is a flow chart of a unidirectional testing process embodiment of the present invention.

FIG. 5 is a flow chart of a bi-directional testing process embodiment of the present invention.

FIG. 6 is a flow chart of the process for automated ARP determination.

### BEST MODE OF CARRYING OUT THE INVENTION

Overview

In general, the testing method of the present invention entails launching copies of real attack or protocol traffic across a computer network to be picked up by the IDS system, firewall and other access/traffic control components. The test attacks or protocols are built based upon real network traffic from actual attacks and communication protocols, which are recorded and manipulated. The test attacks or protocols are then launched and evaluated to report on how the access/traffic control components coped and responded to those attacks or protocols.

This allows attack/protocol traffic to be repeatedly played back, using a different IP address for source and destination if desired. Although the test traffic is real, the test traffic is launched without making a live connection to the target host by preventing sequence number matching during the handshake process. As there is no live connection to the target machine the packets will be ignored by the target system and therefore they will not cause any harm or damage. The access/traffic control components will see the test traffic as real traffic and should provide an alert or respond accordingly.

The testing process involves the following basic steps: 1) recording a live traffic pattern from real attacks or protocols (e.g. email, HTTP based attacks, or regular connection over http, telnet etc.) launched against a computer network in a closed lab environment; 2) generating and storing a source file containing the recorded traffic pattern from the attack or protocol; 3) identifying source and destination Internet Protocol (IP) and Media Access Control (MAC) addresses for testing; 4) selecting the playback transmission options such as traffic speed; 5) modifying the recorded header information based upon the selected source and destination addresses for testing and playback transmission options, and re-calculating the checksum for each data packet in accordance with the modified packet header information; 6) transmitting the test traffic pattern with the modified header information on the computer network without establishing a live connection with the component at the destination address and in accordance with the playback transmission options; and 7) monitoring of the transmission and the reaction of the access/traffic control components.

The test parameters are varied in a number of different ways to fully assess the access/traffic control components. In particular, the source and destination of the traffic, the distance of the traffic into the network, the speed of the traffic, and the type of attacks or protocols are all varied to fully and flexibly test the network.

Moreover, the testing operates in either a unidirectional mode (preferred for testing an IDS) or bi-directional mode (preferred for testing a firewall). In the unidirectional mode, the network traffic containing a test attack or protocol is launched onto the network in a harmless fashion and then the IDS and other components are monitored to determine whether the components react, and if so, how they react. In the bi-directional mode, the network traffic containing a test attack or protocol is launched onto the network such that the data packets are transmitted and received between two network interface devices as called for by the traffic pattern. The network devices are preferably placed on either side of the network firewall so as to emulate traffic into and out of the secure area of the network.

System Architecture and Data Flow

The testing system is preferably implemented in the form of software configured to run on a network-enabled computer having at least one network interface device, such as any commercially available network interface card (NIC), for transmitting and receiving data on the network 10 to be tested.

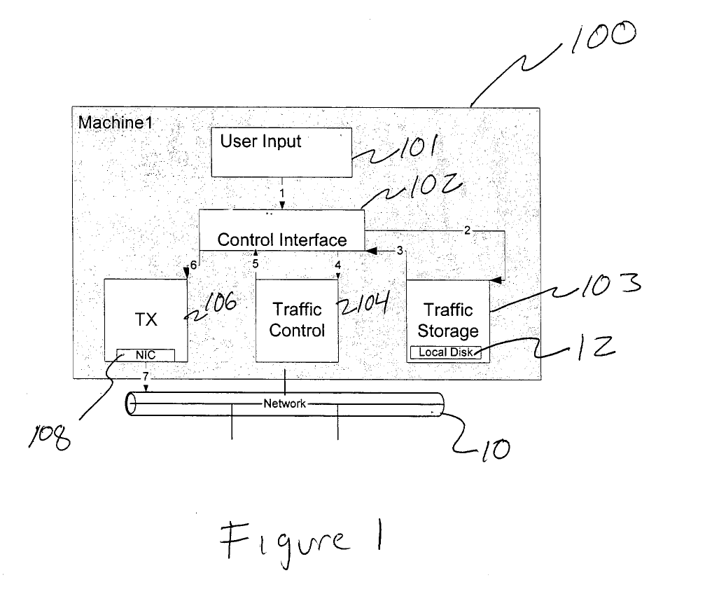

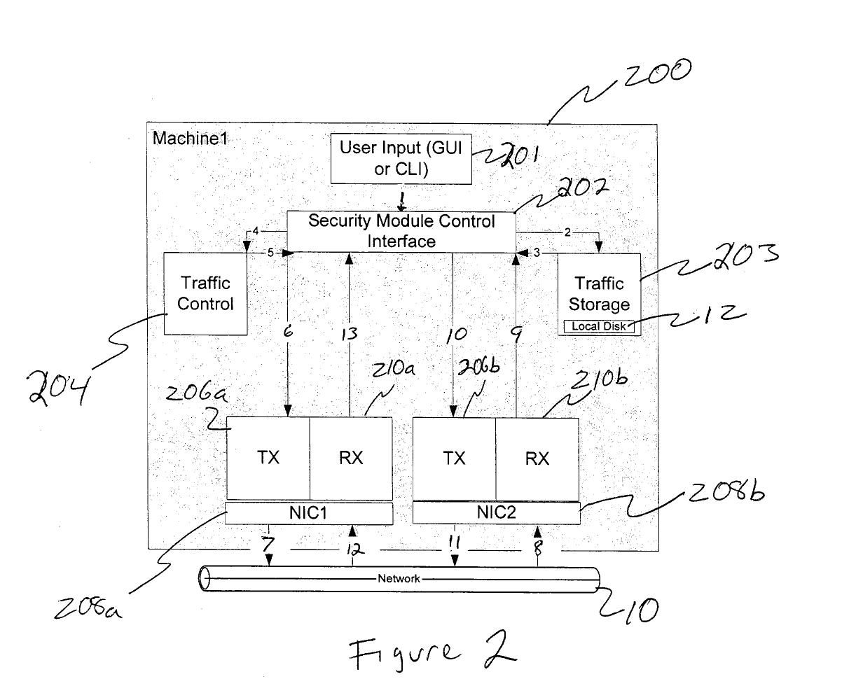

The preferred architecture for the unidirectional mode is depicted in FIG. 1. As shown, software (comprising a multitude of various logical modules for performing various specified functions) controls the operation of network-enabled computer 100, access to storage device 12, and access of network interface device 108 to network 10. Storage device 12 may be any type of well-known storage device (for example, internal hard drive or random access memory (RAM)) located either internal or external to computer 100.

The software includes a number of logical modules for controlling specific functions: user input 101 (such as a graphical user interface (GUI) or command line interface (CLI)) for receiving test parameters from the system operator, security module control interface 14 for controlling data flow among the various software modules, traffic storage 18 for controlling the retrieval of stored traffic patterns on storage device 18, traffic control module 104 for modifying the packets in the traffic pattern in accordance with the test parameters, and packet driver 106 for launching packets onto network 10 via network interface device 108.

In accordance with the numbered logical flow shown in FIG. 1, the system receives the testing parameters from the system operator via user input 101. The parameters specify the particular attack or protocol to launch, IP addresses to emulate, and other pertinent details. The various logical modules then interact in the following order to launch the test traffic:

1) The test parameters are provided by user input 101 to security module control interface 102, which controls the operation of the other modules.

2) Control interface 102 prompts traffic storage module 103 to retrieve the specified attack or protocol traffic pattern from storage device 12.

3) Traffic storage module 103 returns the attack or protocol traffic pattern to control interface 102.

4) Control interface 102 passes the attack traffic or protocol pattern to traffic control module 104, which modifies the attack or protocol traffic pattern in accordance with the user specified test parameters.

5) Traffic control module 104 passes the modified traffic pattern back to control interface 102.

6) Control interface 102 passes the modified traffic pattern to packet driver 106 for launch onto network 10.

7) Packet driver 106 launches the packets in the modified traffic pattern onto network 10 via network interface device 108 in accordance with the test parameters until all of the packets are transmitted.

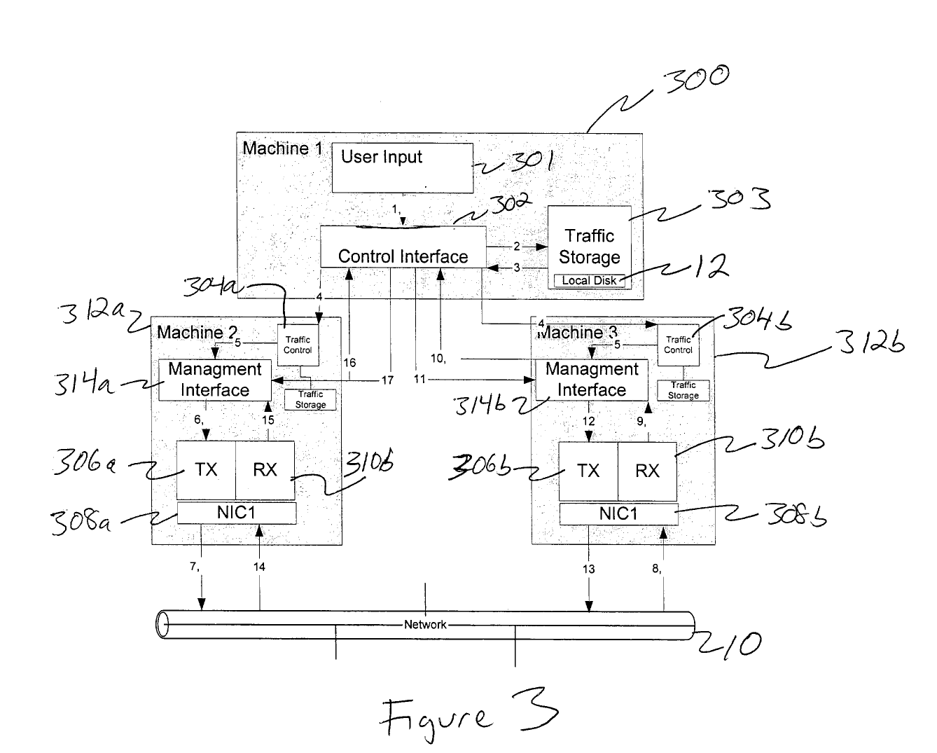

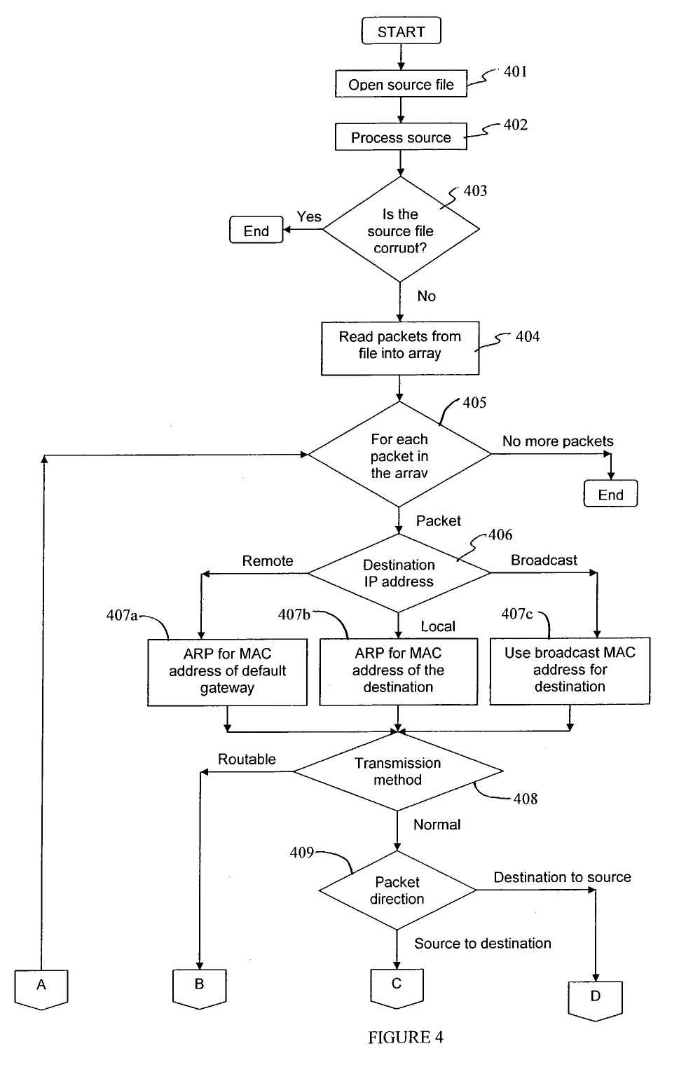

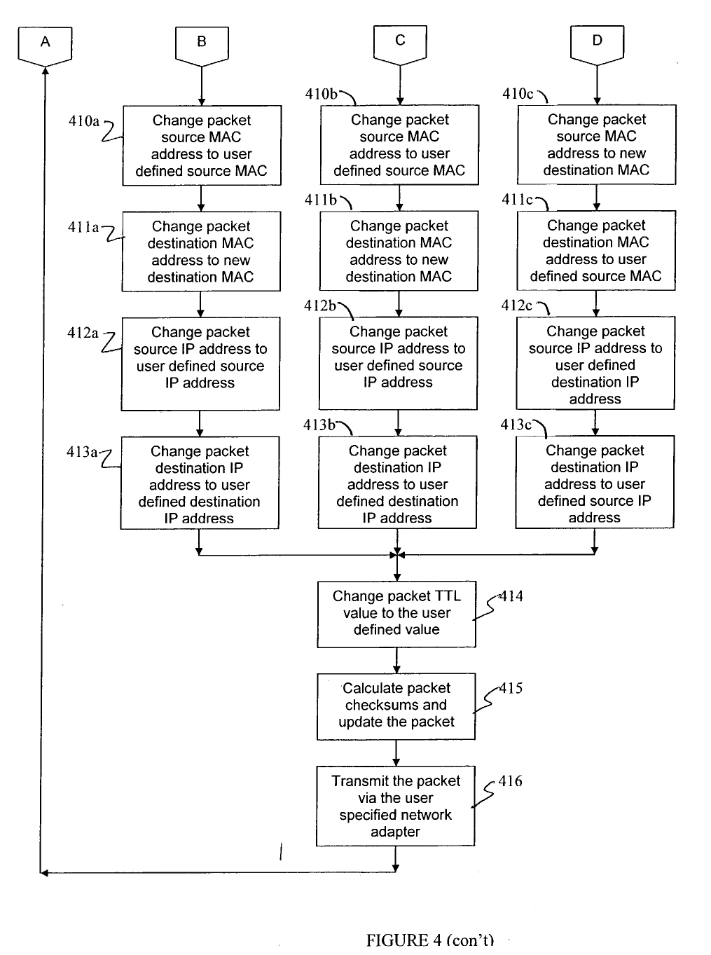

Local and remote network interface embodiments for the bi-directional configuration are depicted in FIGS. 2 and 3, respectively. The bi-directional configuration includes all of the same logical and functional components of the unidirectional configuration plus additional software modules and hardware components to provide the bi-directional capability.

As shown in FIG. 2, a second packet driver 206b, a second network interface device 208b, and two packet capture modules 210a/210b for capturing packets from the network via network interface cards 208a/208b, respectively, are added to provide the bi-directional capability. In the bi-directional configuration, each network interface device 208 has an associated packet driver 206 and packet capture module 210. Each set functions to emulate a network device on network 10 with a specifically assigned IP address. The packets in the traffic pattern are exchanged between the logical network devices for purposes of testing network 10. The assigned IP addresses can be varied to fully and flexibly test network 10.

In accordance with the numbered logical flow shown in FIG. 2, the system receives the testing parameters from the user via user input 201. The parameters specify the particular attack or protocol to launch, IP addresses to emulate, and other pertinent details. The various logical modules then interact in the following order to launch the test attack:

1) The test parameters are provided by user input 201 to security module control interface 202, which controls the operation of the other modules.

2) Control interface 202 prompts traffic storage module 203 to retrieve the specified traffic pattern from storage device 12.

3) Traffic storage module 203 returns the traffic pattern to control interface 202.

4) Control interface 202 passes the traffic pattern to traffic control module 204, which modifies the traffic pattern in accordance with the user specified test parameters.

5) Traffic control module 204 then passes the modified traffic pattern back to control interface 202. Control interface 202 is now ready to control the bi-directional exchange of the packets by logical network devices 208 in accordance with the test parameters. Communication is local via an API within network-enabled computer 200.

6) Control interface 202 passes the first packet to source packet driver 206a.

7) Source packet driver 206a launches the first packet onto network 10 via source network interface device 208a.

8) Target packet capture module 210b receives the first packet from network 10 via target network interface device 208b.

9) Target packet capture module 210b communicates receipt of the first packet to control interface 202.

10) Control interface 202 passes the second (response) packet to target packet driver 206b.

11) Target packet driver 206b launches the second packet onto network 10 via target network interface device 208b.

12) Source packet capture module 210a receives the second packet from network 10 via source network interface device 208a.

13) Source packet capture module 210a communicates receipt of the second packet to control interface 202.

This process continues until all of the packets in the modified traffic pattern are launched onto network 10, and then the process begins again based upon new test parameters from user input 201.

FIG. 3 depicts an alternative embodiment of the bi-directional configuration, which has extended functionality beyond the embodiment depicted in FIG. 2. The alternate embodiment provides for the location of the logical network devices at separate locations along network 10 remote from the central control device. In this embodiment, the network interface devices 308a/308b are located in remote network enabled computers 312a/312b, respectively. The test traffic pattern passes onto and out of network 10 via remote network enabled computers 312a/312b under the control of central network enabled computer 300. Communication between central network enabled computer 300 and remote network enabled computers 312a/312b is via either a direct wired or wireless connection. This enables testing at different physical locations relative to network 10.

In accordance with the numbered logical flow shown in FIG. 3, the system receives the testing parameters from the user via user input 301. The parameters specify the particular attack or protocol to launch, IP addresses to emulate, and other pertinent details. The various logical modules then interact in the following manner to launch the test attack:

1) The test parameters are provided by user input 301 to security module control interface 302, which controls the operation of the other modules.

2) Control interface 302 prompts traffic storage module 303 to retrieve the specified traffic pattern from storage device 12.

3) Traffic storage module 303 returns the traffic pattern to control interface 302.

4) Control interface 302 passes the traffic pattern via to source and target traffic control modules 304a/304b, which modify the traffic pattern in accordance with the user specified test parameters.

5) Traffic control modules 304a/304b then pass the modified traffic patterns to the respective management interfaces 314a/314b, which control the bi-directional exchange of the packets by logical network devices in accordance with the test parameters.

6) Source management interface 314a passes the first packet to source packet driver 306a, while target management interface 314b stands by.

7) Source packet driver 306a launches the first packet onto network 10 via source network interface device 308a.

8) Target packet capture module 310b receives the first packet from network 10 via target network interface device 308b.

9) Target packet capture module 310b communicates receipt of the first packet to target management interface 314b.

10) Target management interface 314b communicates receipt of the first packet to control interface 302.

11) Control interface 302 commands target management interface 314b to commence transmission of the second packet.

12) Target management interface 314b passes the second (response) packet to target packet driver 306b.

13) Target packet driver 306b launches the second packet onto network 10 via target network interface device 308b.

14) Source packet capture module receives the second packet from network 10 via source network interface device 308a.

15) Source packet capture module 310a communicates receipt of the second packet to source management interface 314a.

16) Source management interface 314a communicates receipt of the second packet to control interface 302.

17) Control interface 302 commands source management interface 314a to commence transmission of the third packet.

This process continues until all of the packets in the modified traffic pattern are launched onto network 10, and then the process begins again based upon new test parameters from user input 301.

The network enabled computer 100/202/302 provides a means for taking real, pre-recorded attack traffic or protocols from a source file and processing it in a way that enables it to be retransmitted on the network to a user specified target IP address, dependent on user specifiable transmission options. This will enable users to test the configuration, accuracy and functionality of network and host based IDS and hardware/software firewall solutions.

Recording of Traffic Patterns

The available attacks and protocols fall into Four main categories. The attacks or protocols are selected by the user to organize the testing and test specific attack or protocol patterns. The four categories are:

1. Passive Reconnaissance which includes passive information gathering techniques, such as trace-route, finger and DNS zone transfer.

2. Active Reconnaissance which includes activities where the attack actually probes the network. This includes attacks such as basic UDP and Nmap port scans, and PHP read attack.

3. Active Attacks which include activities beyond information gathering such as back orifice, imap, and the like.

4. Standard network protocols which includes normal network traffic for example HTTP, FTP, Telnet, POP3 etc.

The testing system allows all, or selected ones, of these attacks or protocols to be launched. Also, attack or protocol groups can be created to launch traffic in predefined groups. For example, all back door attacks, all HTTP attacks, or all Windows attacks. This is also useful for setting up an exercise with security staff by creating a group of attacks and then running them in order.

These known attacks and protocols are compiled and launched, unencumbered against a computer network that resides in a closed lab environment. The data traffic (i.e., data packets between the client and target host) is recorded and stored in a source file. The closed lab environment prevents damage or disabling of live computer networks. Additionally, the compiling, launching, and recording process is long and time consuming. Use of a lab environment allows for storage and later use of the attack/protocol traffic against live networks at anytime.

More specifically, the live attacks are launched against a computer network in a lab environment, and the ensuing traffic (i.e., the packets comprising header information and data) is recorded using a standard network-enabled computer with packet “sniffer” (i.e., capture) software. The required equipment and software are commercially available and well known in the art. An example of a commercially available packet sniffer is Microsoft Corporation's NetMon, which provides for the recording and play back of data packets.

The traffic is recorded into a standard network capture file where the bytes of the original packet are store sequentially and intact. This is the format used by all standard network sniffer applications. Table A, shown below, is an example of the header information for the recorded traffic for a single attack.

TABLE A

| IP addr | MAC address | ChkSum | Type | Dir | MAC address | IP addr |
|---|---|---|---|---|---|---|
| 192.168.1.1 | 00-c0-fe-3c-a2-4a | Ff74 | syn | → | 00-e4-3a-b3-c0-e1 | 192.168.1.2 |
| 192.168.1.2 | 00-e4-3a-b3-c0-e1 | 31c0 | syn/ack | → | 00-c0-fe-3c-a2-4a | 192.168.1.1 |
| 192.168.1.1 | 00-c0-fe-3c-a2-4a | 43a1 | ack | → | 00-e4-3a-b3-c0-e1 | 192.168.1.2 |
| 192.168.1.1 | 00-c0-fe-3c-a2-4a | 2701 | Data | → | 00-e4-3a-b3-c0-e1 | 192.168.1.2 |
| 192.168.1.2 | 00-e4-3a-b3-c0-e1 | 0f47 | Data | → | 00-c0-fe-3c-a2-4a | 192.168.1.1 |
| 192.168.1.1 | 00-c0-fe-3c-a2-4a | De80 | Reset | → | 00-e4-3a-b3-c0-e1 | 192.168.1.2 |

The traffic is then stored with the first (source) IP and MAC addresses replaced, the second (destination) IP and MAC addresses replaced. The 10 replacement IP and MAC addresses are essentially placeholders. The traffic with the placeholders inserted into the header information serves as the source file for later use in the testing of a live network. The exemplary traffic pattern once re-written is shown below in table B.

TABLE B

| IP addr | MAC address | ChkSum | Type | Dir | MAC address | IP addr |
|---|---|---|---|---|---|---|
| 1.1.1.1 | aa-bb-cc-dd-ee-ff | Ff74 | syn | → | 11-22-33-44-55-66 | 2.2.2.2 |
| 2.2.2.2 | 11-22-33-44-55-66 | 31c0 | syn/ack | → | aa-bb-cc-dd-ee-ff | 1.1.1.1 |
| 1.1.1.1 | aa-bb-cc-dd-ee-ff | 43a1 | ack | → | 11-22-33-44-55-66 | 2.2.2.2 |
| 1.1.1.1 | aa-bb-cc-dd-ee-ff | 2701 | Data | → | 11-22-33-44-55-66 | 2.2.2.2 |
| 2.2.2.2 | 11-22-33-44-55-66 | 0f47 | Data | → | aa-bb-cc-dd-ee-ff | 1.1.1.1 |
| 1.1.1.1 | aa-bb-cc-dd-ee-ff | De80 | Reset | → | 11-22-33-44-55-66 | 2.2.2.2 |

This traffic pattern constitutes a test attack or protocol that will be contained in the source file stored on storage device 12. The traffic patterns from all of the available attacks and protocols are placed in the source file, which is encrypted to secure the file and has checksums added to provide for file validation when the source file is later used for testing a live network.

Packet Modification and Transmission

When a user is ready to test a live network, the user selects the source and destination IP address for testing. With respect to the source and destination, the IP addresses can be random or specified which allows the attack or protocol to be targeted as needed. For example the attack or protocol can be routed through the network to test a sensor at a remote location.

The test system via the ARP module then query's the target machines MAC address. Alternatively, the user can supply the MAC address of the target. The user can also specify the source MAC address if desired; otherwise the network assigned MAC addresses are used as depicted in the table above. Additionally, the user selects the rate at which they want the attacks or protocols to launch, that is both the delay between packets in each attack or protocol and between attacks or protocols. The user may also select random IP addresses to simulate a load from a large network.

Once the user has selected the test parameters via user input 101/201/301, test attack or protocol packets are constructed by traffic control modules 104,204,304 from the source file packets by modifying the IP and MAC addresses in accordance with those selected for testing, modifying the playback parameters, and recalculating the checksum to assure the packets are accurate and legitimate. Then, the test attack or protocol packets are played back under the control of control interface 102/202/302 from a selected network card onto the live network being tested. Exemplary header information for playback is shown below in table C.

TABLE C

| IP address | MAC address | ChkSm | Type | Dir MAC address | IP address |
|---|---|---|---|---|---|
| 10.10.10.10 | 1a-2b-3c-4d-5e-6f | C40f | syn | → A1-b2-c3-d4-e5-f6 | 10.10.10.11 |
| 10.10.10.11 | A1-b2-c3-d4-e5-f6 | F702 | syn/ack | → 1a-2b-3c-4d-5e-6f | 10.10.10.10 |
| 10.10.10.10 | 1a-2b-3c-4d-5e-6f | 023a | ack | → A1-b2-c3-d4-e5-f6 | 10.10.10.11 |
| 10.10.10.10 | 1a-2b-3c-4d-5e-6f | Bcf1 | Data | → A1-b2-c3-d4-e5-f6 | 10.10.10.11 |
| 10.10.10.11 | A1-b2-c3-d4-e5-f6 | Aa4f | Data | → 1a-2b-3c-4d-5e-6f | 10.10.10.10 |
| 10.10.10.10 | 1a-2b-3c-4d-5e-6f | C072 | Reset | → A1-b2-c3-d4-e5-f6 | 10.10.10.11 |

The ability to construct and playback packets using any combination of IP addresses and data loads allows the testing system to build legitimate looking traffic that can be used to test an IDS or firewall. However, the test packets (i.e., test attack or protocol) do not harm the network or the target component. The test packets, which contain data representing an otherwise real attack, are ignored by the target component because no connection is ever created between the source and target components.

Many connection-oriented services, such as HTTP, FTP and POP3, utilize the TCP handshake procedure to establish the connection between components. When these applications are launched, the TCP stack on the local device must establish a connection with the TCP stack on the destination device to ensure proper communication. The handshake process is based on three steps. (In this article, the component that initiates the handshake process is called Component 1, and the destination component, or the target of the connection, is called Component 2.

1. Component 1 sends its TCP sequence number and maximum segment size to Component 2.

2. Component 2 responds by sending its sequence number and maximum segment size to Component 1.

3. Component 1 acknowledges receipt of the sequence number and segment size information.

In order to render the test traffic harmless, the test system which controls the source component and, in the bi-directional mode, the target component as well, initiates the handshake procedure but prevents completion of the handshake. Rather than sending the sequence number expected by the target component based upon the handshake, the packets transmitted by the source components utilize a different sequence number. Since the sequence numbers do not match, the target component will receive but will not process the packet. This prevents the attack from infiltrating or harming the target component. The test system will then continue to launch the packets from the test traffic onto network 10. The packets will travel along an expected path based upon the source and destination addresses designated in the packet header. The various access and traffic control components on network 10 will perceive the packets as real traffic. However, once the packets reach the designated destination, the recipient component (e.g., a web server or email server) will be unharmed.

The detailed process for modifying and transmitting the packets from the traffic source file is explained step-by-step below. Both the unidirectional and bi-directional processes are explained.

The core software module in unidirectional mode will facilitate the following:

1. Open and process the user specified source file that contains data in the form of network packets.

2. Process each packet changing the appropriate bytes dependent on user specified options.

3. Transmit the changed packets via the network dependent on user specified options.

The unidirectional process includes the following steps and sub-steps: Pre-processing of the source file (performed by traffic storage module 103 Open the source file: The source file is based on a standard network capture file where the bytes of the original packet are store sequentially and intact. This is the format used by all standard network sniffer applications

401. Decrypt the source file header: During the processing of the source file we add an encrypted header that contains the original files attributes.

402. Check the source file attributes: By comparing the attributes from the header to the source file attributes, we can determine if the file has been corrupted or tampered with. If this is the case an error is displayed and the network data is not transmitted.

403. Read the source file packets into an array in memory: The source file is parsed and each packet is read into an array in memory.

Repeat process for each packet in the array (performed by control interface 102)

404. Check for more packets: If there are no more packets in the area, the process is complete. If there are more packets, the process continues to step 406.

Identify the MAC address of the target machine (performed by traffic control 104)

406. Determine whether the destination IP address is a remote, local or broadcast address: The MAC address determination is dependent upon the destination the destination IP address (specified via user input 101.

407. ARP for the target MAC address: If the target machine is on a remote network, an ARP request is sent to the default gateway to determine the MAC address of the default gateway (step 407a). If the destination IP address is on the local network, an ARP request is sent to determine the MAC address of the target machine (step 407b). If the destination IP address is a broadcast address, for example 192.168.255.255, there is no need to send an ARP request and the broadcast MAC address is assumed “FFFFFFFFFFFF” (step 407c).

Determine the transmission option (performed by traffic control 104)

408. Decide how the packets will be transmitted: If the Routable transmission option is selected, all the packets will be changed to set the source IP address to be the source IP address specified by the user, and the source MAC address will be changed to the source MAC address specified by the user. In other words, with the Routable transmission option all of the packets will be modified (starting with step 410a) such that the packets will be sent from machine A to machine B. If the Normal transmission option is selected, further inquiry is as to the packet direction is carried out in step 409.

409. Determine the packet direction: If the transmission method is Normal, the direction is determined (i.e., source to destination or destination to source) in order to maintain the state of the original packets. For example ‘Normal’ transmission will change the packets preserving their bi-directional conversation if applicable, machine A sends to machine B then machine B replies to machine A and so on. Source to destination packets are next processed in accordance with step 410b. Destination to source packets are next processed in accordance with step 410c.

Changing data in the original packets (performed by traffic control 104)

410. Change the source MAC address of the packet: Each packet in the array is then parsed and the appropriate source MAC addresses are replaced dependent on the transmission option selected. If the packet is routable, the packet source MAC address is set to the user-defined source MAC address (step 410a). If the packet is a normal transmission from source to destination, the packet source MAC address is set to the user-defined source MAC address (step 410b). If the packet is a normal transmission and from the destination to source, the packet source MAC address is set to the new destination MAC address (step 410c).

411. Change the destination MAC address of the packet: Each packet in the array is then parsed and the appropriate destination MAC addresses are replaced dependent on the transmission option selected. If the packet is routable, the packet destination MAC address is set to the new destination MAC address (step 411a). If the packet is a normal transmission from source to destination, the packet source MAC address is set to the new destination MAC address (step 411b). If the packet is a normal transmission and from the destination to source, the packet source MAC address is set to the user-defined source MAC address (step 411c).

412. Change the source IP address of the packet: Each packet in the array is then parsed and the appropriate source IP addresses are replaced dependent on the transmission option selected. If the packet is routable, the packet source IP address is set to the user-defined source IP address (step 412a). If the packet is a normal transmission from source to destination, the packet source IP address is set to the user-defined source IP address (step 412b). If the packet is a normal transmission and from the destination to source, the packet source IP address is set to the user-defined destination IP address (step 412c).

413. Change the destination IP address of the packet: Each packet in the array is then parsed and the appropriate destination IP address is replaced dependent on the transmission option selected. If the packet is routable, the packet destination IP address is set to the user-defined destination IP address (step 413a). If the packet is a normal transmission from source to destination, the packet destination IP address is set to the user-defined destination IP address (step 413b). If the packet is a normal transmission and from the destination to source, the packet destination IP address is set to the user-defined source IP address (step 413c).

414. Change the ‘time to live’: Replace the ‘time to live’ (TTL) value in each packet to the user specified value. This will effect how far the packets will travel across the network before they are dropped.

Checksum the changed packets (performed by traffic control 104)

415. Calculate the new packet checksums: A checksum is calculated for each packet and the result is inserted into the packet replacing the original checksum. At this point the changed packets are ready for transmission on the network.

Transmitting the packets (performed by packet driver 106 and control interface 102).

416. Transmitting the packets applying the user specified transmission options: All of the changed packets in the array are then transmitted to the network via the network card specified by the user. The other user specifiable options that will affect the transmission of the packets are the delay in milliseconds between sending each packet, the pause in milliseconds to wait before sending each packet, the delay in seconds between sending each attack or protocol, the pause in seconds to wait before sending each set of packets from a source file, and the infinite loop option where all of the packets are continuously transmitted in an infinite loop.

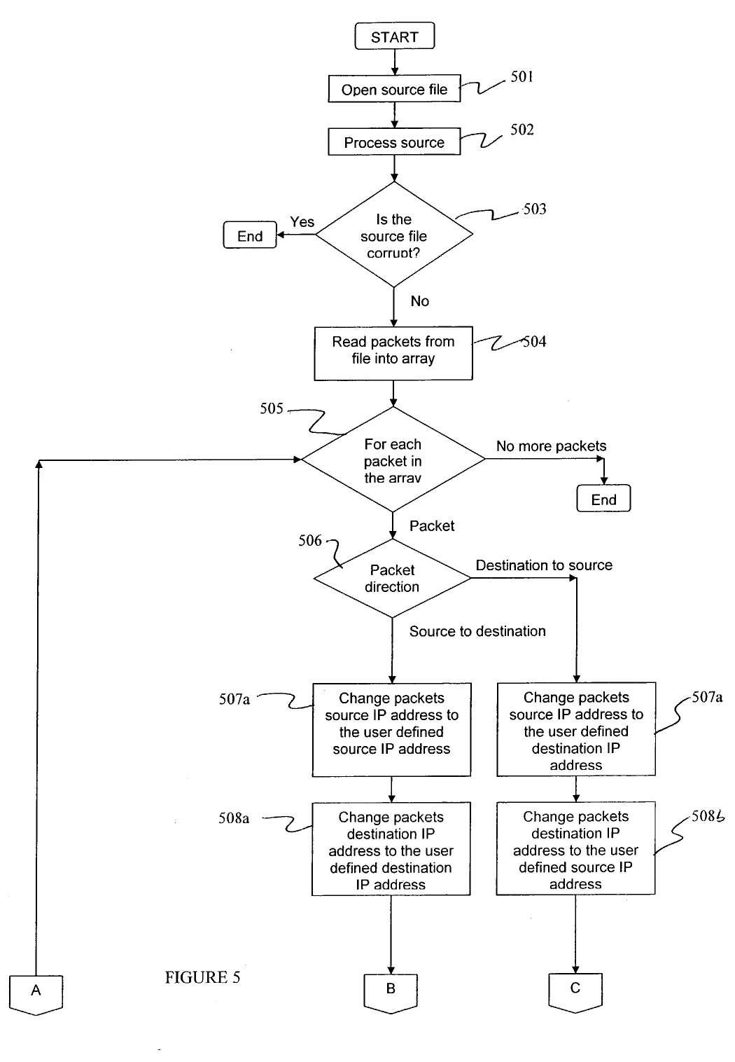

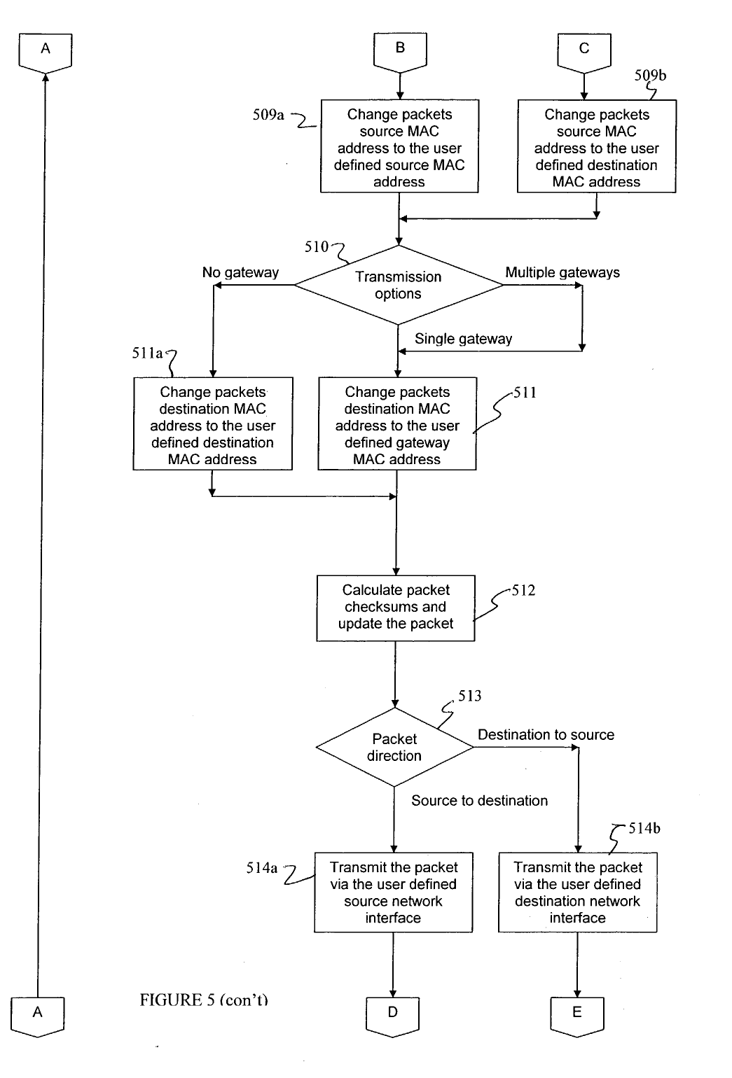

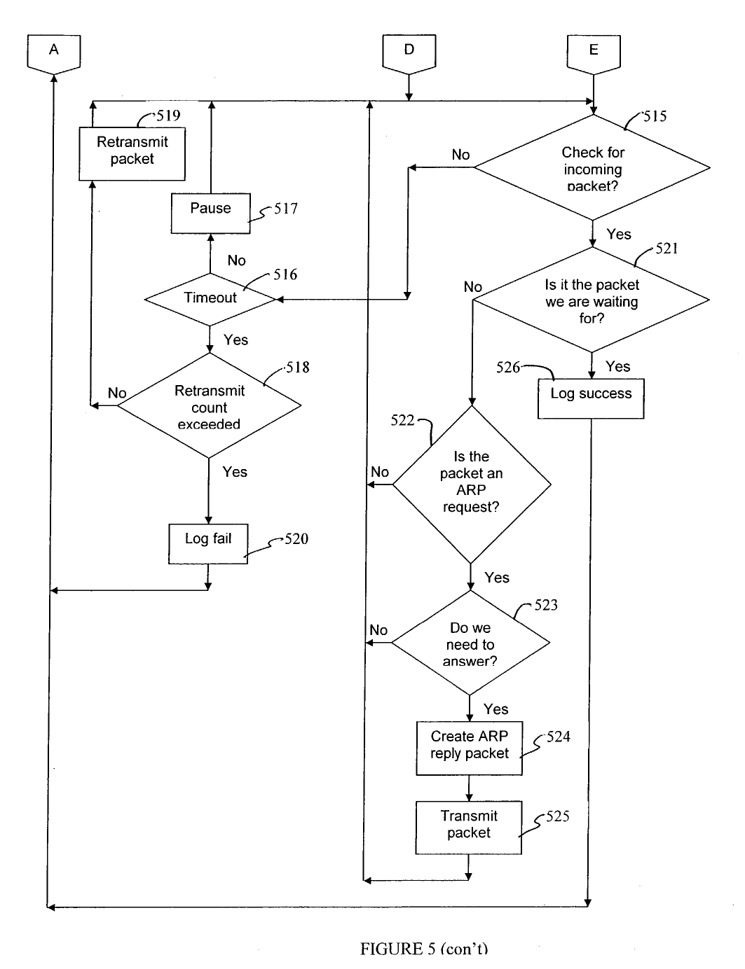

Alternately, multiple network agents (either network interface cards in the test computer or remote agents) at different locations in the network space being tested enable the more robust bi-directional mode testing process. This provides a means for taking network data from a source file, then processing it in a way that enables it to be retransmitted on the network via two network cards, dependent on user specifiable transmission options. This will enable users to test the configuration and accuracy of hardware/software firewall solutions. The dual probe process is depicted in FIG. 5 and described in detail below.

The core software module in bi-directional mode will facilitate the following:

1. Open and process the user specified source file that contains data in the form of network packets.

2. Process each packet changing the appropriate bytes dependent on user specified options.

3. Transmit each changed packet via the appropriate network card (dependent on user specified options), and then listen for the transmitted packet to be received by the other network card.

The bi-directional process includes the following steps and sub-steps: Pre-processing of the source file (performed by traffic storage module 203/303)

501. Open the source file: The source file is based on a standard network capture file where the bytes of the original packet are store sequentially and intact. This is the format used by all standard network ‘sniffer’ applications.

502. Decrypt the source file header: During the processing of the source file we add an encrypted header that contains the original files attributes.

503. Check the source file attributes: By comparing the attributes from the header to the source file attributes, we can determine if the file has been corrupted or tampered with. If this is the case an error is displayed and the network data is not transmitted.

504. Read the source file packets into an array in memory: The source file is parsed and each packet is read into an array in memory.

505. Check for more packets: If there are no more packets in the area, the process is complete. If there are more packets, the process continues to step 506.

506. Determine the packet direction: Source to destination packets are next processed in accordance with step 507a. Destination to source packets are next processed in accordance with step 507b.

507. Change the source IP address of the packet: Each packet in the array is then parsed and the appropriate source IP addresses are replaced dependent on the transmission option selected. If the packet is being transmitted from source to destination, the packet source IP address is set to the user-defined source IP address (step 507a). If the packet is being transmitted from destination to source, the packet source IP address is set to the user-defined destination IP address (step 507b).

508. Change the destination IP address of the packet: Each packet in the array is then parsed and the appropriate source IP addresses are replaced dependent on the transmission option selected. If the packet is being transmitted from source to destination, the packet destination IP address is set to the user-defined destination IP address (step 508a). If the packet is being transmitted from destination to source, the packet destination IP address is set to the user-defined source IP address (step 508b).

509. Change the source MAC address of the packet: Each packet in the array is then parsed and the appropriate source MAC addresses are replaced dependent on the transmission option selected. If the packet is being transmitted from source to destination, the packet source MAC address is set to the user-defined source MAC address (step 509a). If the packet is being transmitted from destination to source, the packet source MAC address is set to the user-defined destination MAC address (step 509b).

510. Determine the gateway transmission options: If the packet destination is local, then proceed to step 511a. If the destination is through a single or multiple gateways, then proceed to step 511b.

511. Change the destination MAC address: Each packet in the array is then parsed and the appropriate destination MAC addresses are replaced dependent on the transmission option selected. If the packet is not being transmitted through a gateway, the packet destination MAC address is set to the user-defined destination MAC address (step 511a). If the packet is being transmitted through multiple gateways, the packet destination MAC address is set to the user-defined gateway MAC address (step 511b). Change the ‘time to live’: Replace the ‘time to live’ (TTL) value in each packet to the user specified value. This will effect how far the packets will travel across the network before they are dropped.

512. Calculate the new packet checksums: A checksum is calculated for each packet and the result is inserted into the packet updating the original checksum. At this point the changed packets are ready for transmission on the network.

Transmitting the packets (performed by packet drivers 206/306, packet capture modules 210/310, control interface 202/302, and management interfaces 314)

513. Determine the packet direction: Source to destination packets are next transmitted in accordance with step 514a. Destination to source packets are next transmitted in accordance with step 514b.

514. Transmitting the packets applying the user specified transmission options: If the packet is being transmitted from source to destination, then the packet is transmitted via the source network interface device 208a/308a (step 514a). If the packet is being transmitted from destination to source, then the packet is transmitted via the destination network interface device 208b/308b (step 514b). The other user specifiable options that will affect the transmission of the packets are the delay in milliseconds between sending each packet, the pause in milliseconds to wait before sending each packet, the delay in seconds between sending each attack, the pause in seconds to wait before sending each set of packets from a source file, and the infinite loop option where all of the packets are continuously transmitted in an infinite loop.

Analyzing received packets (performed by packet capture module 210/310 and traffic control 204/304).

515. Check for incoming packets: The network interface device 208/308 that did not transmit the packet listens and reports whether the packet was received. If a packet was not received, then the process proceeds to step 516. If a packet was received, the process proceeds to step 521.

516. Determine if process has timed out: If the time since the packet transmission has passed a pre-set limit, then the process proceeds to step 518. If the time limit has not been exceeded, then the process continues to step 517.

517. Pause: The process is delayed for a pre-set amount of time before proceeding back to step 515 to check again for an incoming packet.

518. Check retransmission count: A check is performed to determine if the retransmission count exceeds a pre-set limit. If the limit is not exceeded, the process proceeds to step 519. If the limit is exceeded, the process proceeds to step 520.

519. Retransmit: The retransmission counter is incremented by one and the packet is retransmitted.

520. Log failure: A transmission failure event is logged and the process proceeds back to step 505 check for more packets.

521. Verify if correct packet: The packet is examined to determine if it is the packet that was sent. If it is not the correct packet, then the process proceeds to step 522. If it is the correct packet, the process proceeds to step 526.

522. Determine if ARP request: The packet, which is not the expected packet, is examined to determine if it is an ARP request. If the packet is an ARP request, the process proceeds to step 523. If the packet is not an ARP request, the process proceeds back to step 515 to check again for the expected incoming packet.

523. Determine if answer required: Examine the ARP request packet to determine if a response is required. If a response if required, the process proceeds to step 524. If no response is required, the process proceeds back to step 515 to check again for the expected incoming packet.

524. Create ARP reply: An ARP reply packet is created in response to the ARP request packet and the process proceeds to step 525.

525. Transmit ARP reply: The ARP reply packet is transmitted onto network 10 and then the process proceeds the process proceeds back to step 515 to check again for the expected incoming packet.

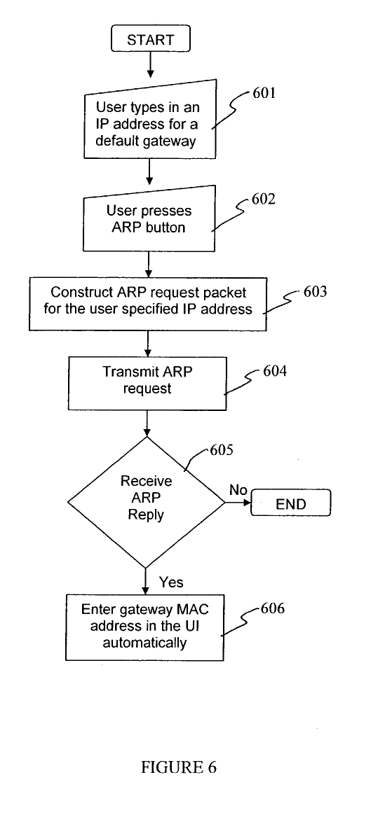

Often the system operator is aware of the IP address of a gateway but not the corresponding MAC address. The system of the present invention includes an automated ARP process to retrieve the gateway MAC address for a designated gateway IP address. An embodiment of this process is depicted in FIG. 6. As shown, the system operator enters the default gateway IP address into user input 201/301 (step 601) and clicks the ARP button displayed on user input 201/301 (step 602). ARP module then constructs an ARP request packet for the designated gateway IP address (step 603), and packet driver 206a/306a transmits the ARP request onto network 10 (step 604). If packet capture module 210a/310a receives an ARP reply from the network's ARP server (step 605), then ARP module enters the gateway MAC address into the display of user input 201/301 automatically (step 606).

Playback Transmission Options

The test parameters (i.e., playback transmission options) are varied in a number of different ways to fully assess the access/traffic control components. In particular, the source and destination of the attack or protocol, the distance of the attack or protocol into the network, the speeds of the attack or protocol, and the type of attacks or protocols are all varied to fully and flexibly test the network.

Distance control is used to prevent the attack or protocol from leaking out of network 10 by limiting the number of routers (i.e., network hops) the packets will traverse, thus keeping the packets within a defined network space. The distance is regulated by building the test attack packets with a pre-defined Time to Live (TTL) variable, which is measured by network hops. For example, if a user wants to test a sensor on a segment but does not want it to leave the network, the packets can be sent with a TTL of 0. This is very desirable when using random IP addresses where the possible IP address may reside on a separate network from the one that is being tested. Also, when targeting large ranges of IP addresses it is desirable to make sure attacks or protocols do not leak beyond the desired network. The appropriate value for the TTL is determined by simply counting the number of components between the source and the target.

Traffic packet delay can be selected for all attack/protocol runs to add a delay between attacks/protocols and the packets within an attack or protocol. This is useful in several environments. Where the sensors are located on low bandwidth segments it may be desired to space the attacks out so as to not flood the pipe with packets. This will also allow the software to be used to setup emergency drills for the security department, but spread the attacks apart to simulate an actual attack.

The delay between attacks/protocols is preferably on the order of seconds. The delay between packets in a multi-packet attack or protocol is preferably on the order of milliseconds. For example if an attack has 5 packets, and the delay is set to 1 millisecond then the attack would take 4 milliseconds plus the time it takes to broadcast the packets themselves.

Monitoring

An attack log is maintained on network-enabled computer 100/200/300, which provides a graphical listing of attacks and protocols, with their corresponding source and destination IP addresses, as the attacks or protocols are launched. This allows the attacks or protocols to be matched up with the results from the access/traffic control components in real time.

Also, a trace route application is integrated into the network-enabled computer 100/200/300 to provide more functionality in the daily use and troubleshooting of the access/traffic control components. When testing, it is desirable to know the route that packets will take through the network. This enables the user to limit attacks or protocols to only the desired access/traffic control components. Additionally, if the access/traffic control component does not detect any of the test attacks or protocols, running a trace-route to one of the targets can be tried. If this trace route reaches the destination, there may be a problem with the access/traffic control component or its connectivity to the network that is preventing it from receiving packets. Trace route can also be used to select target machines. Once the user has run a successful trace route, selecting the component's IP address as the destination IP address for the test attack can target any of the components along the way.

The trace route can be run using either Internet Control Message Protocol (ICMP) or User Datagram Protocol (UDP). ICMP is the standard method by which trace-route is normally run. UDP can be used when either a firewall or router along the route blocks ICMP. Of note, ICMP still needs to be allowed as a response back. Even though outbound is UDP the return is ICMP. If ICMP traffic is blocked in both directions, the return packets will not reach network-enabled computer 100/212/312.

System Operation

In operation, when a new access/traffic control component, such as an IDS, has been installed, it is recommended to run all attacks against it to verify that it has picked up all attacks. This can be done using a test computer (e.g., network-enabled computer 100/200/300) and any of the following methods.

1. Cross over cable between the test computer and the IDS. This assures no interference between external devices and these two machines. This configuration is also desirable when the network requires 0 attack traffic on the live network.

2. The test computer and IDS are connected to a hub. The hub can be on the live network or a test network with just the two testing components connected. If the only two machines are the test computer and the IDS, this configuration has all the benefits of a cross over cable.

3. The test computer is connected to one network segment, and the IDS into another. This requires that the attack traffic traverse the actual network. While this should not harm any of the intermediary devices, it does interject some uncertainty that the IDS will see the traffic.

While any of the three above options will work, it is preferred that the first option be used to verify the IDS is functioning. Once this has happened the third option is preferred with a smaller set of attacks. This second test does not require the entire attack suite as that has already been tested using the first option. This test is mainly to test the IDS has been connected to the network in the desired location, or that it is functioning properly.

This second test is also a useful time to test any secondary responses the IDS may be executing. For example, if the IDS is configured to send out e-mails in response to some attacks, it is useful to send this attack using the test computer to assure e-mail is being sent. This sort of test can also be used to safely test a firewall reconfiguration due to the test computer's ability to spoof a source destination.

Once these tests have been run the test attack report should be compared to what the IDS reports in its display as well as reports to validate the data has arrived in all desired locations.

Once the IDS has been put in place and verified to be working, it is desirable to occasionally test the IDS to assure continued compliance. This is done simply by creating an attack group and running this attack group on a weekly, monthly or other desired schedule, and then comparing the results in the same way as the initial testing. This sort of test is very useful in an environment such as managed services where the customer needs assurance that the system is working as desired. Typically, this should be done using the third setup option.

In many environments such as the military, and schools etc., events such as fire drills are carried out. These are done to ensure that an overall system is working smoothly as opposed to just an individual component. In the same way, the testing is used to do this as well by launching predefined attack runs that the security team is not aware of. The security team can then be monitored to see how they respond, and if the response is satisfactory. With the present invention's ability to reproduce the same attack identically any number of times, the user can test multiple teams with the knowledge that they are responding to the same information. With the growing number of attacks and the speed at which new attacks are being released, IDS systems are constantly being upgraded with new features and attack lists. The testing software is also constantly updated to include these new attacks. With this in mind, whenever a new version of the IDS is installed the new attacks should be tested with the testing system.

From the above description, it will be apparent that the invention disclosed herein provides a novel and advantageous method and apparatus for testing computer network access and traffic control systems. The foregoing discussion discloses and describes merely exemplary methods and embodiments of the present invention. One skilled in the art will readily recognize from such discussion that various changes, modifications and variations may be made therein without departing from the spirit and scope of the invention.

We claim:

1. A method of testing a computer network comprising the steps of:
recording header information of data packets in a live traffic pattern on the computer network, wherein the header information of each of the data packets includes at least a source address, a destination address, and a checksum;
identifying source and destination addresses for testing of the computer network;
modifying the recorded header information by replacing the source and destination addresses of the recorded header information with the source and destination addresses for testing, and re-calculating the checksum for each data packet based upon the source and destination addresses for testing; and
transmitting a test traffic pattern with the modified header information on the computer network without establishing a live connection with the destination address.

2. The method recited in claim 1, wherein the source and destination addresses include an IP address and a MAC address, and the modifying step replaces the IP address and the MAC address of the source and destination addresses in the recorded traffic pattern.

3. The method recited in claim 1, further comprising the steps of:
selecting a delay between data packets in the test traffic pattern;
wherein the data packets in the test traffic pattern are delayed by the selected delay during the transmitting step.

4. The method recited in claim 1, further comprising the steps of:
selecting a limit on the number of routers that data packets in the test traffic pattern may traverse on the computer network;
wherein the modifying step also includes the step of changing the recorded header information based upon the selected limit.

5. The method recited in claim 1, wherein the live traffic pattern is recorded sequentially and intact.

6. The method recited in claim 1, further comprising the steps of:
generating a log of the transmitting of the test traffic pattern.

7. The method recited in claim 1, further comprising the steps of:
repeating the modifying step for multiple source and destination addresses; and
sequentially transmitting the multiple test traffic patterns.

8. The method recited in claim 7, further comprising the steps of:
selecting a delay between playing back of the multiple test traffic patterns;
wherein the sequential transmitting step delays the multiple test traffic patterns by the selected delay.

9. The method recited in claim 7, further comprising the step of:
selecting random source and destination addresses to simulate a load from a large computer network.

10. The method recited in claim 1, further comprising the steps of:
receiving the transmitted test traffic pattern; and
determining if the transmitted test traffic pattern is received.

11. A method of constructing a test attack on a computer network, comprising the steps of:
recording header information of data packets in a live traffic pattern on the computer network, wherein the header information of each of the data packets includes at least an IP and MAC source address, an IP and MAC destination address, and a checksum;
identifying source and destination addresses for testing of the computer network; and
modifying the recorded header information to form a test attack traffic pattern by replacing the source and destination addresses of the recorded header information with the source and destination addresses for testing, and re-calculating the checksum for each data packet based upon the source and destination addresses for testing.

12. The method recited in claim 11, further comprising the steps of:
selecting a limit on the number of routers that data packets in the test traffic pattern may traverse on the computer network;
wherein the modifying step also includes the step of changing the recorded header information based upon the selected limit.

13. The method recited in claim 11, wherein the live traffic pattern is recorded sequentially and intact.

14. A system for testing a computer network by transmission of a test traffic pattern on the computer network having a plurality of data packets, each data packet having header information where the header information of each of the data packets includes at least a source address, a destination address, and a checksum, the system comprising:
a source network interface agent configured to transmit a test traffic pattern on the computer network;
a destination network interface agent configured to receive test traffic pattern on the computer network;
a central controller, wherein the central controller generates the test traffic pattern by replacing the source and destination addresses of header information from a pre-recorded live traffic pattern with source and destination addresses corresponding to the source and destination network interface agents, and re-calculates the checksum for each data packet in the test traffic pattern; and
wherein the central computer directs the source network interface agent to transmit the test traffic pattern and the destination network interface agent to receive the test traffic pattern.

15. The system recited in claim 14, wherein the central controller delays the transmission of the data packets in the test traffic pattern by a selected delay.

16. The system recited in claim 14, wherein the central controller limits the number of routers that the data packets in the test traffic pattern may traverse on the computer network.

17. The system recited in claim 14, wherein the central controller generates a log of the transmission of the test traffic pattern.

18. The system recited in claim 14, wherein the central controller generates test traffic patterns for multiple source and destination addresses, and directs the source network interface agent to sequentially transmit the multiple test traffic patterns.

19. The system recited in claim 18, wherein the central controller delays the transmission of the multiple test traffic patterns by a selected delay.

20. The system recited in claim 18, wherein the central controller selects random source and destination addresses to simulate a load from a large computer network.

21. The system recited in claim 14, wherein the network interface agents are network interface cards directly coupled to the central controller.

22. The system recited in claim 14, wherein the network interface agents are connected to the computer network at locations remote from the central controller.

23. A system for testing a computer network by transmission of a test traffic pattern on the computer network having a plurality of data packets, each data packet having header information where the header information of each of the data packets includes at least a source address, a destination address, and a checksum, the system comprising:
a plurality of network interface agent configured to transmit and receive a test traffic pattern on the computer network from one network interface agent to another; and
a central controller, wherein the central controller selects one of the plurality of network interface agents as a source and another of the plurality of network interface agents as a destination, generates the test traffic pattern by replacing the source and destination addresses of header information from a pre-recorded live traffic pattern with source and destination addresses corresponding to the selected network interface agents, re-calculates the checksum for each data packet in the test traffic pattern, and controls the transmission of the data packets in the test traffic pattern between the selected network interface agents.

24. The system recited in claim 23, wherein the central controller delays the transmission of the data packets in the test traffic pattern by a selected delay.

25. The system recited in claim 23, wherein the central controller limits the number of routers that the data packets in the test traffic pattern may traverse on the computer network.

26. The system recited in claim 23, wherein the central controller generates a log of the transmission of the test traffic pattern.

27. The system recited in claim 23, wherein the central controller generates test traffic patterns for multiple source and destination addresses, modifies the addresses of the selected network interface agents to correspond to the multiple source and destination addresses, and directs the selected network interface agents to sequentially transmit the multiple test traffic patterns.

28. The system recited in claim 27, wherein the central controller delays the transmission of the multiple test traffic patterns by a selected delay.

29. The system recited in claim 27, wherein the central controller selects random source and destination addresses to simulate a load from a large computer network.

30. The system recited in claim 23, wherein the plurality of network interface agents are network interface cards directly coupled to the central controller.

31. The system recited in claim 23, wherein the plurality of network interface agents are connected to the computer network at locations remote from the central controller.

32. The system recited in claim 14, wherein the central controller generates the test traffic pattern such that no live connection is created with the selected network interface agent receiving the data packets in the test traffic pattern.

33. The system recited in claim 23, wherein the central controller generates the test traffic pattern such that no live connection is created with the selected network interface agent receiving the data packets in the test traffic pattern.
